(19) United States
(12) Patent Application Publication
(10) Pub. No.: US 2009/0165321 A1
(43) Pub. Date: Jul. 2, 2009

(54) DRYER HAVING GAS HEATER

(75) Inventor: Chang Hoo Kim, Gyeyang-gu (KR)

Correspondence Address: SCHMEISER, OLSEN & WATTS, 22 CENTURY HILL DRIVE, SUITE 302, LATHAM, NY, 12110, US

(73) Assignee: DAEWOO ELECTRONICS CORPORATION, SEOUL (KR)

(21) Appl. No.: 12/342,299

(22) Filed: Dec. 23, 2008

(30) Foreign Application Priority Data
Dec. 27, 2007 (KR) 10-2007-0139507

(51) Int. Cl. F26B 21/00; D06F 58/20; D06F 58/26

(52) U.S. Cl. 34/72; 432/120; 432/222

(57) ABSTRACT

A dryer having a gas heater includes: a mixing pipe for mixing gas with air; and a flame holder installed on the mixing pipe, wherein the flame holder has a body placed opposite to a discharge port of the mixing pipe and formed with a through hole part, and a support extended from the body to be mounted to the mixing pipe; the support has a mounting part fastened to the mixing pipe and a fixing part connecting the mounting part and the body; and a width of the fixing part is narrower than a width of the mounting part.

### CROSS-REFERENCE TO RELATED APPLICATIONS

The present application claims priority to Korean patent application number 10-2007-0139507, filed on Dec. 27, 2007, which is incorporated by reference in its entirety.

### BACKGROUND OF THE INVENTION

The present invention relates to a dryer, and more particularly, to a dryer having a gas heater which can prevent incomplete combustion.

FIG. 1 is a structural view showing a flow path of a conventional dryer and FIG. 2 is a partially broken perspective view of the conventional dryer.

Referring to FIGS. 1 and 2, the conventional dryer includes a cabinet 2 which forms an external appearance of the dryer and provided with an opening formed in front thereof and through which laundries to be dried are put into the dryer, a drum 12 which is rotatably mounted inside the cabinet 2 to accommodate the laundries to be dried and has opened front and rear portions for allowing air to pass therethrough, a heater 18 which heats the air sucked into the cabinet 2, an intake duct 20 which guides the heated air passed through the heater 18 to the rear of the drum 12, an exhaust unit 22 which exhausts the air polluted by drying the laundries to the outside of the cabinet 2, a blower fan (not shown) which is installed in the exhaust unit 22, and a motor (not shown) and a belt 40 which drive the drum 12 and the blow fan to be rotated.

A lifter 11 is mounted on an inner peripheral surface of the drum 12 to lift up and drop the laundries to be dried.

The exhaust unit 22 includes a lint duct 25 which filters foreign substances from the air by a filter 24 mounted therein, a fan housing 26 which communicates with the lint duct 25 and houses the blower fan and an exhaust duct 27 which communicates with the fan housing 26 at one end thereof and extends to the outside of the cabinet 2 at the other end.

Operation of the conventional dryer having the above described structure will be described.

By operating the dryer after putting the laundries to be dried into the drum 12 and closing a door (not shown), the motor is driven to rotate the drum 12 and the blower fan, and the heater 18 is operated together.

As the drum 12 is rotated, the laundries to be dried in the drum 12 are lifted up and dropped by the lifter 11.

External air is sucked in the heater 18, heated to air with high temperature and low humidity and then supplied to the inside of the drum 12 through the intake duct 20.

The air with high temperature and low humidity supplied to the inside of the drum 12 is brought into contact with the laundries to dry the laundries. As the dry process goes on, the supplied air is gradually changed to air with low temperature and high humidity, moved to the front of the drum 12 and then exhausted to the outside of the dryer through the exhaust unit 22.

In the conventional dryer, when a gas heater is employed, there are problems that an amount of gas consumed to operate the dryer is increased and a large amount of various foreign substances are generated since a flame produced by the gas is incompletely burned. Therefore, it is required to improve the problems.

### SUMMARY OF THE INVENTION

In the conventional dryer, when a gas heater is employed, there are problems that an amount of gas consumed to operate the dryer is increased and a large amount of various foreign substances are generated since a flame produced by the gas is incompletely burned

Therefore, it is required to improve the problems.

Embodiments of the present invention are directed to a dryer having a gas heater which can prevent the incomplete combustion of the gas.

In one embodiment, a dryer having a gas heater includes: a mixing pipe for mixing gas with air; and a flame holder installed on the mixing pipe, wherein the flame holder has a body placed opposite to a discharge port of the mixing pipe and formed with a through hole part, and a support extended from the body to be mounted to the mixing pipe; the support has a mounting part fastened to the mixing pipe and a fixing part connecting the mounting part and the body; and a width of the fixing part is narrower than a width of the mounting part.

Preferably, the body has a plurality of wings formed at the periphery of the body, and a diameter of the through hole part is greater than a distance from the wing to the mixing part.

More preferably, the diameter of the through hole part is 9.8 to 12.2 mm and the distance from the wing to the mixing pipe is 8.8 to 9.2 mm.

More preferably, wherein the diameter of the through hole part is 9.8 to 10.2 mm.

According to the present invention, since the width of the fixing part is narrower than the width of the mounting part. Therefore, it is possible to prevent that the mixture injected from the mixing pipe is flowed back toward the mixing pipe after collided with the fixing part and to prevent the resultant backflow of the flame.

Also, according to the present invention, by improving the structure of the through hole part and the wing, it is possible to prevent the incomplete combustion and thus reduce the foreign substances generated upon the incomplete combustion, and also reduce the amount of the gas consumed to drive the dryer.

### BRIEF DESCRIPTION OF THE DRAWINGS

FIG. 1 is a structural view showing a flow path of a conventional dryer.

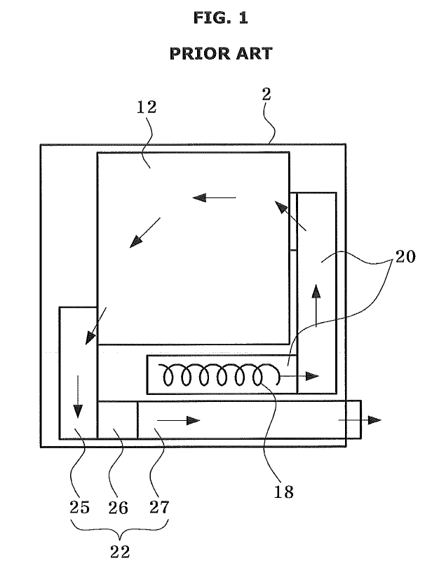

FIG. 2 is a partially broken perspective view of the conventional dryer.

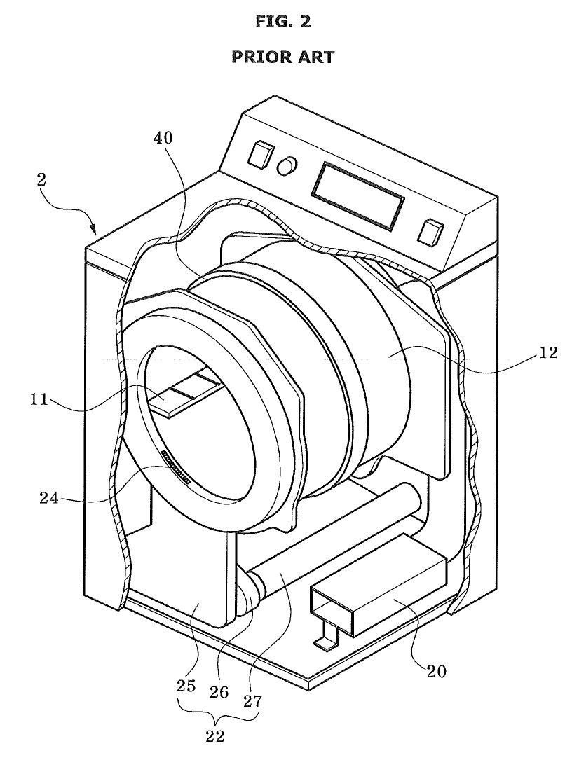

FIG. 3 is a structural view illustrating a dryer having a gas heater in accordance with an embodiment of the present invention.

FIG. 4 is an exploded perspective view illustrating the gas heater in accordance with an embodiment of the present invention.

FIG. 5 is a perspective view illustrating a nozzle of the gas heater in accordance with an embodiment of the present invention.

FIG. 6 is a longitudinal sectional view illustrating the nozzle of the gas heater in accordance with an embodiment of the present invention.

FIG. 7 is a perspective view illustrating a flame holder of the gas heater in accordance with an embodiment of the present invention.

FIG. 8 is a plan view illustrating an intake flow path of a dryer having the gas heater in accordance with an embodiment of the present invention.

FIG. 9 is a side sectional view illustrating a circulation flow path of the dryer having the gas heater in accordance with an embodiment of the present invention.

FIG. 10 is a plan view illustrating an exhaust flow path of the dryer having the gas heater in accordance with an embodiment of the present invention.

FIG. 11 is a graph showing content of carbon monoxide in exhaust gas of the dryer having a nozzle and a flame holder for LPG in accordance with an embodiment of the present invention.

FIG. 12 is a graph showing content of carbon monoxide in exhaust gas of the dryer having a nozzle and a flame holder for LNG in accordance with an embodiment of the present invention.

### DESCRIPTION OF SPECIFIC EMBODIMENTS

Hereinafter, an exemplary embodiment of the present invention will be described with reference to accompanying drawings. For convenience of description, a dryer having a gas heater will be described by way of example. It should be noted that the drawings are not to precise scale and may be exaggerated in thickness of lines or size of components for the purpose of convenience and clarity only.

Furthermore, terms used herein are defined in consideration of functions in the present invention and can be changed according to the custom or intention of users or operators. Thus, definition of such terms should be determined according to overall disclosures set forth herein.

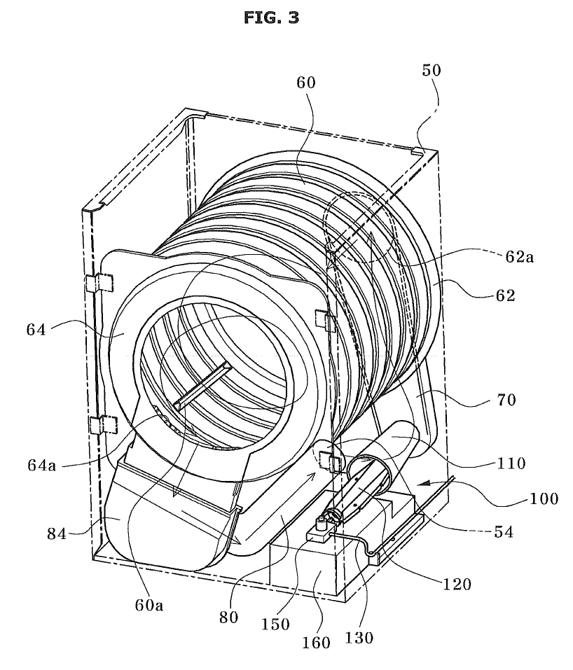

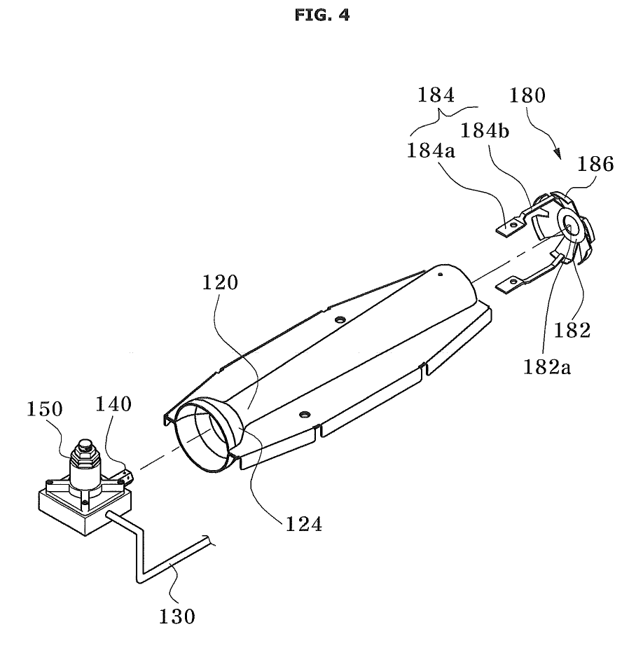

FIG. 3 is a structural view illustrating a dryer having a gas heater in accordance with an embodiment of the present invention and FIG. 4 is an exploded perspective view illustrating the gas heater in accordance with an embodiment of the present invention.

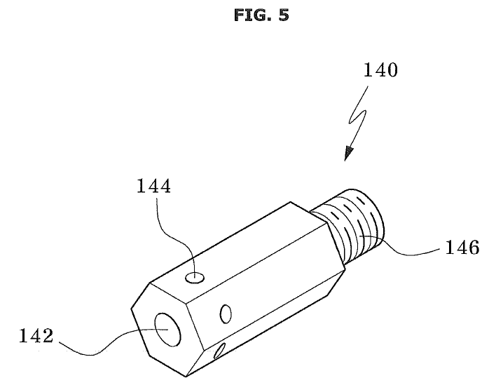

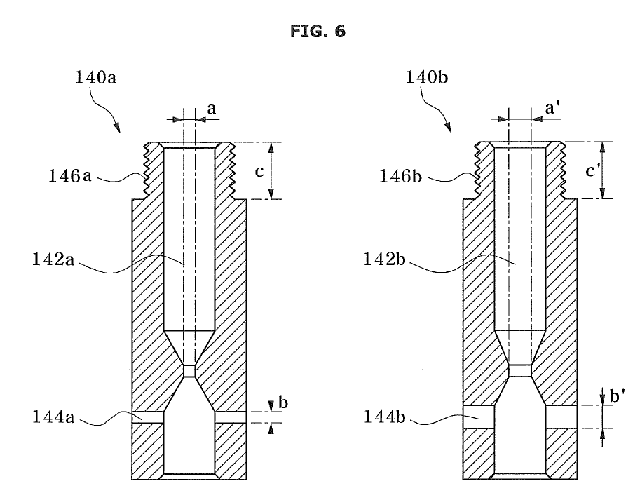

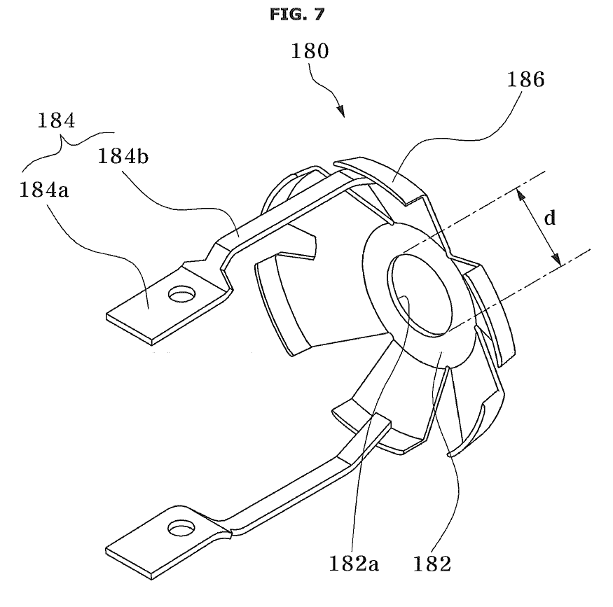

FIG. 5 is a perspective view illustrating a nozzle of the gas heater in accordance with an embodiment of the present invention; FIG. 6 is a longitudinal sectional view illustrating the nozzle of the gas heater in accordance with an embodiment of the present invention; and FIG. 7 is a perspective view illustrating a flame holder of the gas heater in accordance with an embodiment of the present invention.

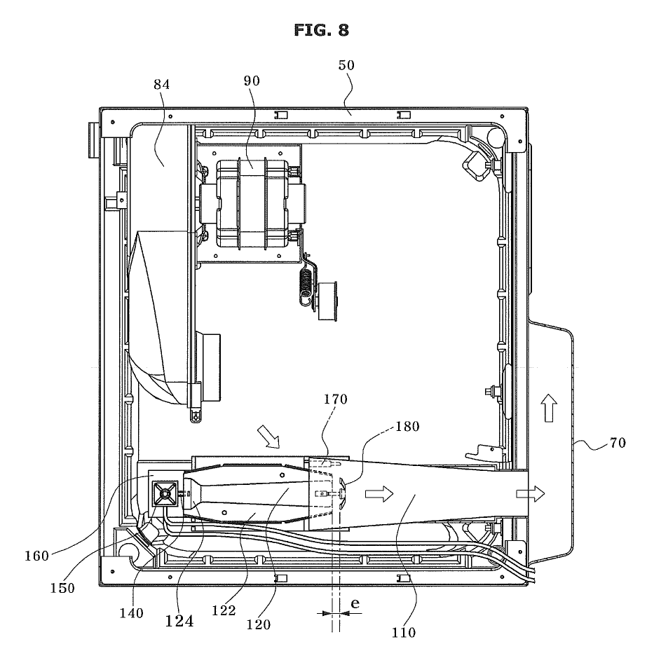

Referring to FIGS. 3 to 7, a dryer in accordance with an embodiment of the present invention includes a cabinet 50 which has a predetermined space therein and is provided with an opening and discharge port 54, a drum 60 which is rotatably mounted in an inside of the cabinet 50 to accommodate the laundries to be dried, a lifter 60a which is mounted on an inner wall of the drum 60 to lift up the laundries to be dried, an intake duct 70 which guides air inside the cabinet 50 to the inside of the drum 60, a gas heater 100 installed in the intake duct 70, an exhaust fan 82 (refer to FIG. 8) which is provided between the drum 60 and the discharge port 54, an exhaust duct 80 which is provided between the exhaust fan 82 and the discharge port 54 and a driving motor 90 (refer to FIG. 8) which is connected with a rotation shaft of the exhaust fan 82.

When power is applied to the driving motor 90, the exhaust fan 82 is rotated to circulate air and the air flowed in the inside of the cabinet 50 is changed to high temperature air while passing the gas heater 100.

The air is supplied to the inside of the drum 60 along the intake duct 70 and is brought into contact with the laundries to perform drying operation or sterilizing operation.

After that, the air exhausted by the exhaust fan 82 is flowed along the exhaust duct 80 and exhausted to an outside through the discharge port 54 of the cabinet 50, thereby completing the circulation of the air.

The drum 60 is formed in a cylindrical shape with opened front portion, which corresponds to the opening, and rear portion, and is rotatably mounted to a support panel 62 which is formed with a through hole part 62a.

The support panel 62 is mounted at a rear side of the cabinet 50 to rotatably support the drum 60. Also, the through hole part 62a of the support panel 62 is communicated with the intake duct 70.

A front panel 64 is installed between the front end portion of the drum 60 and the opening of the cabinet 50 and is formed with an exhaust hole 64a at a lower end portion thereof.

The exhaust hole 64a is connected with a connection duct 84 which is extended toward the exhaust fan 82, and a housing (not shown) for housing the exhaust fan 82 therein is placed between the connection duct 84 and the exhaust duct 80.

The intake duct 70 is extended from the gas heater 100 to the through hole part 62a. Therefore, the air is changed to air having a temperature higher than a predetermined temperature while passing through the gas heater 100 and flowed along the intake duct 70 to be supplied to the inside of the drum 60 through the through hole part 62a.

At this time, since a contact area between the high temperature air and the laundries to be dried is increased as the drum 60 connected with the driving motor 90 by a belt (not shown) is rotated, the efficiency of the drying and sterilizing operation is enhanced.

The gas heater 100 includes a gas pipe 130 for supplying gas, a valve 150 for controlling supply and cutoff of the gas and an amount of the supplied gas, a nozzle 140 provided at a side of the valve 150, a mixing pipe 120 placed corresponding to the nozzle 140 to mix the gas and the air, an ignition plug 170 (refer to FIG. 8) mounted on the mixing pipe 120 to generate sparks, a guide duct 110 placed at an outside of the mixing pipe 120 to guide the heated air, a bracket 160 for mounting the mixing pipe 120 to the cabinet 50, and a flame holder 180 placed in the mixing pipe 120 to prevent that a flame produced by the ignition plug 170 becomes larger than a predetermined size.

As the valve 150 is opened, the gas is supplied to the mixing pipe 120 along the gas pipe 130. Then, the gas is mixed with the air inside the cabinet 50 and injected to the outside of the mixing pipe 120 and the flame is produced by the sparks generated in the ignition plug 170.

Size and production position of the flame are controlled by the flame holder 180, so that the flame is placed inside the guide duct 110. The air flowed in along the guide duct 110 is changed to a hot wind with a high temperature while passing through the flame.

The mixing pipe 120 is formed with a mixing part 124 at one side thereof to allow the air inside the cabinet 50 to be flowed therein. Since the mixing part 124 includes an opening which is larger diameter than that of the nozzle 140, the gas injected from the nozzle 140 and air flowed in are mixed with each other in the mixing part 124.

The mixing part 124 is formed in such a manner that an end of the mixing part 120 is extended and has a hollow cylindrical shape with an opening formed at the end thereof corresponding to the nozzle 140.

The nozzle 140 is communicated with the gas pipe 130 and detachably mounted on the valve 150. The nozzle 140 includes a gas injection passage 142 along which the gas is injected, air intake passages 144 communicated with the gas injection passage 142 to allow the air to be flowed into the gas injection passage 142 and fastening part 146 for mounting the nozzle 140 to the valve 150.

When the valve 150 is opened and the gas is supplied to the mixing pipe 120 along the gas pipe 130, the gas is supplied to the mixing pipe 120 through the gas injection passage 142. At this time, the air is flowed in the air intake passage 144 and the gas and the air are thus mixed with each other.

A cross section a of the gas injection passage 142 is formed smaller than a cross section b of the air intake passage 144. The cross section a of the gas injection passage 142 refers to the smallest of cross sections of the flow path of the gas injection passage 142 and the cross section b of the air intake passage 144 refers to the smallest of cross sections of the flow path of the air intake passage 144.

In the present embodiment, the cross sections of the gas injection passage 142 and the air intake passage 144 are described to have substantially a circular shape by way of an example. That is to say, in the present embodiment, a diameter a of the gas injection passage 142 is formed smaller than a diameter b of the air intake passage 144.

Also, a length c of the fastening part 146 is formed greater than the diameter b of the air intake passage 144. Herein, The diameter a of the gas injection passage 142 refers to the smallest of diameters of the flow path of the gas injection passage 142 and a flow velocity of the gas is increased while passing the section with such small diameter.

From the result of measuring shape, color and an amount of carbon monoxide (CO) due incomplete combustion caused by the nozzles 140 having various structures while controlling the diameter a of the gas injection passage 142, the diameter b of the air intake passage 144 and the length c of the fastening part 146, it could be appreciated that the incomplete combustion is prevented when the nozzle 140 has the shape as above described and the flame produced by the combustion of the gas is close to a blue flame.

The nozzle 140 includes a nozzle 140a for a first gas and a nozzle 140b for a second gas. In the present embodiment, the nozzle 140a for a first gas is a nozzle 140a for Liquefied Petroleum Gas (LPG) and nozzle 140b for a second gas is a nozzle 140b for Liquefied Natural Gas (LNG).

Referring to FIG. 6, the diameter a of the gas injection passage 142a of the LPG nozzle 140a is formed smaller than the diameter a′ of the gas injection passage 142b of the LNG nozzle 140b and the diameter b of the air intake passage 144a of the LPG nozzle 140a is formed smaller than the diameter b′ of the air intake passage 144b of the LNG nozzle 140b.

A caloric value of the LNG is smaller than a caloric value of the LPG. Therefore, since a more amount of the LNG should be supplied compared to the LPG, the diameters of the LNG nozzle 140b is formed greater than the diameters of the LPG nozzle 140a.

In the case of the LPG nozzle 140a, it is preferable that the diameter a of the gas injection passage 142a is 1.2 to 1.6 mm, the diameter b of the air intake passage 144a is 1.8 to 2.2 mm and the length c of the fastening part 146a is 3.8 to 4.2 mm.

When considering the noise, the optimum flame is produced preferably when the diameter a of the gas injection passage 142a is 1.4 mm, the diameter b of the air intake passage 144a is 2.0 mm and the length c of the fastening part 146a is 4 mm.

In the case of the LNG nozzle 140b, it is preferable that the diameter a′ of the gas injection passage 142b is 1.8 to 2.2 mm, the diameter b′ of the air intake passage 144b is 2.8 to 3.2 mm and the length c′ of the fastening part 146b is 3.8 to 4.2 mm.

When considering the noise, the optimum flame is produced preferably when the diameter a′ of the gas injection passage 142b is 2.0 mm, the diameter b′ of the air intake passage 144b is 3.0 mm and the length c′ of the fastening part 146b is 4 mm.

In a case of manufacturing the LPG nozzle 140a and the LNG nozzle 140b so as to produce the optimum flame, the LPG nozzle 140a supplies the gas of about 3.5 L/min and the LNG nozzle 140b supplies the gas of about 8.0 L/min, thereby capable of generating the caloric value of about 5,040Kcal/h.

The nozzle 140 has a shape of a polygonal prism and each face forming the polygon is formed with the air intake passage 144. When the air intake passage 144 is formed on the face of the polygon, processing of the air intake passage 144 can be facilitated and a shape error generated upon the processing as compared with a nozzle of which air intake passage is formed on edge of the polygon.

Particularly, it is preferable that the sectional shape of the nozzle 140 is formed in a hexagon and the air intake passage 144 is formed on each face forming the hexagon. By forming the nozzle in the structure as described above, the optimum flame can be produced.

This structural characteristic is also determined, as the structure capable of producing the optimum flame, from the results of a plurality of experiments performed by varying the sectional shape of the nozzle 140 and varying the number of the air intake passage 144.

The flame holder 180 is installed in the mixing pipe 120 so as to be disposed between the mixing pipe 120 and the guide duct 110. A mixture of the air and the gas forms a vortex by the flame holder 180 and the mixture is thus burned in the vicinity of flame holder 180.

The flame holder 180 includes a body 182 formed with a through hole part 182a through which the mixture supplied through the mixing pipe 120 is injected, and a plurality of supports 184 which are extended from the body 182 to be connected with an end portion of the mixing pipe 120.

The body 182 is formed in a ring shape, in which the through hole part 182a is formed in the middle of the ring and a plurality of the wings 186 is formed at the periphery of the ring. The wings 186 are provided in plural in a radial direction on the periphery of the body 182, and a pair of the supports 184 is extended from the wings 186 which oppose to each other. The wing 186 is bended towards the mixing pipe 120 with a predetermined angle.

The mixture injected to the outside of the mixing pipe 120 is ignited by the sparks generated by the ignition plug 170. Since the mixture are spread by the body 182 of the flame holder 180, particularly by the wings 186, the flame produced is not formed long along the guide duct 110 but is gathered in the vicinity of the flame holder 180. Therefore, it is possible to prevent the mixing pipe 120 or the intake duct 70 is deformed or damaged by the flame.

The support 184 includes a mounting part 184a fastened to the mixing pipe 120 and a fixing part 184b which connects the mounting part 184a and the body 182, and a width of the fixing part 184b is narrower than a width of the mounting part 184a. Therefore, it is possible to prevent that the mixture injected from the mixing pipe 120 is flowed back toward the mixing pipe 120 after collided with the support 184 and to prevent the resultant backflow of the flame.

Table 1 below shows the result of measurement of internal reflection of the burning flame and a temperature in a hot wind intake part while varying a diameter d (refer to FIG. 7) of the through hole part 182a and a distance e (refer to FIG. 8) from the wing 186 to the mixing pipe 120 in order to adjust the temperature of the hot wind to 270 to 300° C. without internal reflection of the burning flame.

TABLE 1

| | | Internal reflection | Temperature in hot |
|---|---|---|---|
| e (mm) | d (mm) | of flame | wind intake part (° C.) |
| 8 | 7 | ◯ | 280 |
| | 8 | ◯ | 270 |
| | 9 | X | 260 |
| | 10 | X | 255 |
| | 11 | X | 250 |
| | 12 | X | 240 |
| 9 | 7 | ◯ | 315 |
| | 8 | ◯ | 300 |
| | 9 | ◯ | 290 |
| | 10 | X | 280 |
| | 11 | X | 275 |
| | 12 | X | 270 |
| 10 | 7 | ◯ | 345 |
| | 8 | ◯ | 340 |
| | 9 | ◯ | 330 |
| | 10 | ◯ | 325 |
| | 11 | X | 315 |
| | 12 | X | 305 |

As can be seen from Table 1, it is preferable that the diameter d of the through hole part 182a is formed greater than the distance from the wing 186 to the mixing pipe 120. Specifically, the diameter d of the through hole part 182a is 9.8 to 12.2 mm and the distance e from the wing 186 to the mixing pipe 120 is 8.8 to 9.2 mm. When considering the temperature of the hot wind intake part, the diameter d of the through hole part 182a is more preferably 9.8 to 10.2 mm.

When the diameter d of the through hole part 182a and the distance e from the wing 186 to the mixing pipe 120 are as aforementioned, the flame has such a shape that the flame is clustered around the body 182 and a blue flame is also formed, thereby capable of preventing the incomplete combustion of the gas.

Meanwhile, a cut part is provided at the side of the wing 186 adjacent to the ignition plug 170 to allow more amount of gas to be flowed toward the ignition plug 170, thereby capable of improving ignition performance.

Hereinafter, operation of gas heater in accordance with an embodiment of the present invention and the dryer having the gas heater will be described.

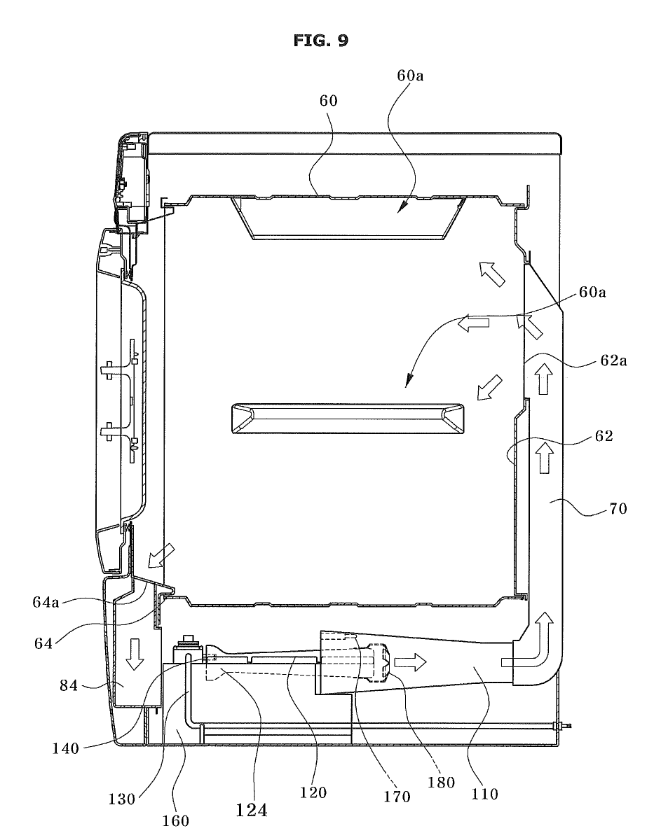

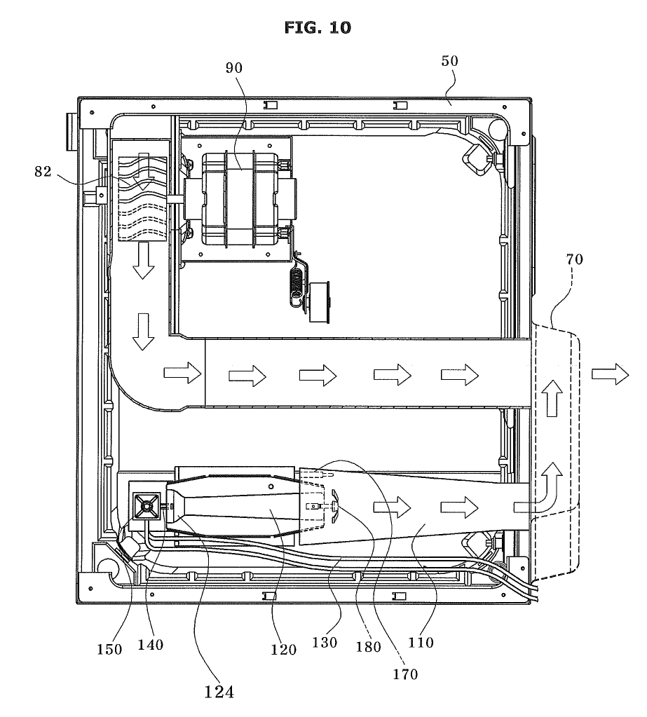

FIG. 8 is a plan view illustrating an intake flow path of a dryer having the gas heater in accordance with an embodiment of the present invention; FIG. 9 is a side sectional view illustrating a circulation flow path of the dryer having the gas heater in accordance with an embodiment of the present invention; and FIG. 10 is a plan view illustrating an exhaust flow path of the dryer having the gas heater in accordance with an embodiment of the present invention.

Referring to FIGS. 5 to 10, when a user manipulates an operation button (not shown), the power is applied to the driving motor 90 to rotate the exhaust fan 82 and the drum 60. By the driving of the exhaust fan 82, the air flowed in the inside of the cabinet 50 is moved to an upside of the cabinet 50 along the intake duct 70 vertically formed on a rear face of the cabinet 50.

As the valve 150 is opened and the gas is supplied along the gas pipe 130, the gas supplied passes through the nozzle 140 to be injected to the inside of the mixing pipe 120. The gas is primarily mixed with the air flowed in through the nozzle 140 and secondarily mixed with the air flowed in through the space between the mixing pipe 120 and the nozzle 140.

Herein, gas/air ratio of the mixture is determined by the shape of the nozzle 140, or the structural characteristics of the nozzle 140 such as the diameter a of the gas injection passage 142, the diameter b of the air intake passage 144 and the length c of the fastening part 146, and the incomplete combustion can be prevented when these structural parts has the dimensions as described above. Of course, though the distance between the nozzle 140 and the mixing pipe 120 is a factor that determines the gas/air ratio of the mixture, in the present invention, the distance between the nozzle 140 and the mixing pipe 120 is considered to be the same as that conventionally used in the art and thus not be described specifically.

When the mixture of the air and gas is injected through the mixing pipe 120, the flame is produced by the ignition plug 170. Since the injected mixture collides with the flame to form a vortex, the flame is laterally spread in the vicinity of the flame holder 180.

At this time, since the fixing part 184b of the support 184 has narrower width than the width of the mounting part 184a, the support 184 of the flame holder 180 can prevent that the mixture moving toward the support 184 is collided with the support 184 and then flowed back. Since the flame is spread in the vicinity of the body 182 of the flame holder 180 and is prevented from being flowed back to the mixing pipe 120 along the support 184, it is possible to prevent the incomplete combustion.

Also, since this flame is gathered in a middle of the guide duct 110 by the flame holder 180, it is possible to prevent the deformation or damage of the mixing pipe 120 and the intake duct 70. This is because it is possible to prevent that the flame is formed long inside the guide duct 110 as the mixture is spread by the body 182 and the wing 186 of the flame holder 180 and it is thus possible to prevent that the flame is produced at a position close to the intake duct 70.

The air flowed in the inside of the intake duct 70 along the guide duct 110 is heated to hot dry air while being brought into contact with the flame. After that, the air flowed in the inside of the drum 60 through the through hole part 62a is swirled and brought into contact with the laundries to be dried to perform the dry operation.

The front panel 64 placed between an inner wall of the cabinet 50 and the opening of the drum 60 is formed with an exhaust hole 64a. The air is exhausted to the outside of the drum 60 through the exhaust hole 64a, flowed to the housing 86 of the exhaust fan 82 through the connection duct 84 communicated with the exhaust hole 64a, then move from the housing 86 along the exhaust duct 80 and finally exhausted to the outside of the cabinet 50 through the discharge port 54.

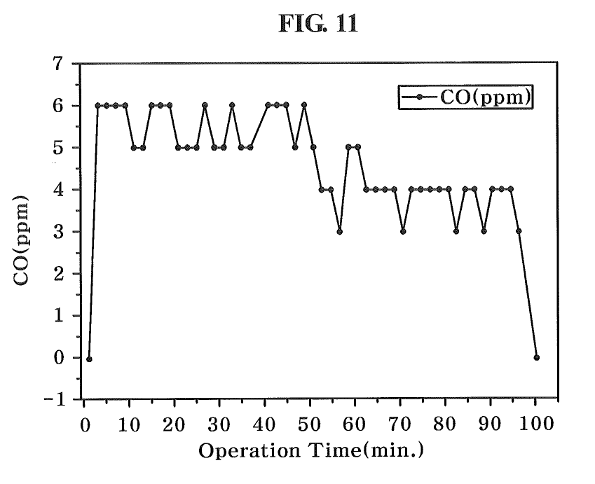

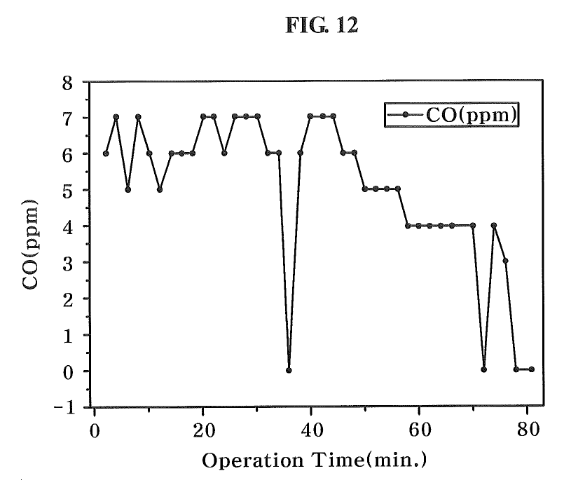

FIG. 11 is a graph showing content of carbon monoxide in exhaust gas of the dryer having a nozzle and a flame holder for LPG in accordance with an embodiment of the present invention and FIG. 12 is a graph showing content of carbon monoxide in exhaust gas of the dryer having a nozzle and a flame holder for LNG in accordance with an embodiment of the present invention.

Referring to FIGS. 5 to 7, 11 and 12, the dimensions of the nozzle 140 and the flame holder 180 as described above are determined, as the optimum dimensions, in an experiment, in which shape and color of the flame and carbon content in the exhaust gas according to structural variation of the nozzle 140 and the flame holder 180, performed on August, 2007 by New Energy Laboratory in department of mechanical engineering of Incheon University according to a request of present assignee.

In addition, the nozzle 140 and the flame holder 180 manufactured with the above described dimensions were installed in the dryer to be subject to a safety inspection. Particularly, with respect to the content of carbon monoxide in the exhaust gas, the content of the carbon monoxide was detected by less than 6 ppm in a dryer with the LPG nozzle 140a and by less than 7 ppm in a dryer with the LNG nozzle 140b. Therefore, it can be appreciated that the incomplete combustion is prevented.

Although the present invention has been described with reference to the embodiments shown in the drawings, it should be understood that these embodiments are provided for illustrative purpose and that various equivalent modifications and alterations will be apparent to those skilled in the art without departing from the scope and spirit of this invention.

In addition, although the present invention has been described with reference to the dryer as specifically described herein, it should be noted that the dryer has been illustrated by way of example, and that the mixing pipe of the present invention may be applied to a gas heater of other product, without being limited to the dryer in its application.

Therefore, the scope and sprit of the invention is limited only by the claims set forth herein as follows.

What is claimed is:

1. A dryer having a gas heater, comprising:
a mixing pipe for mixing gas with air; and
a flame holder installed on the mixing pipe,
wherein the flame holder has a body placed opposite to a discharge port of the mixing pipe and formed with a through hole part, and a support extended from the body to be mounted to the mixing pipe;
the support has a mounting part fastened to the mixing pipe and a fixing part connecting the mounting part and the body; and
a width of the fixing part is narrower than a width of the mounting part.

2. The dryer having a gas heater of claim 1, wherein the body has a plurality of wings formed at the periphery of the body, and a diameter of the through hole part is greater than a distance from the wing to the mixing part.

3. The dryer having a gas heater pipe of claim 2, wherein the diameter of the through hole part is 9.8 to 12.2 mm and the distance from the wing to the mixing pipe is 8.8 to 9.2 mm.

4. The dryer having a gas heater pipe of claim 3, wherein the diameter of the through hole part is 9.8 to 10.2 mm.
